(19) United States
(12) Patent Application Publication
(10) Pub. No.: US 2013/0021260 A1
(43) Pub. Date: Jan. 24, 2013

(54) METHOD FOR INPUTTING KOREAN CHARACTER ON TOUCH SCREEN

(71) Applicant: Sung-Jae Hwang, Daejeon (KR)

(72) Inventor: Sung-Jae Hwang, Daejeon (KR)

(73) Assignee: SAMSUNG ELECTRONICS CO. LTD., Suwon-si, Gyeonggi-do (KR)

(21) Appl. No.: 13/522,200

(22) PCT Filed: Nov. 16, 2010
(86) PCT No.: PCT/KR2010/008108

§ 371 Date: Jul. 13, 2012

(30) Foreign Application Priority Data
Jan. 13, 2010 (KR) 10-2010-0002913

(51) Int. Cl. G06F 3/041; G06F 3/02

(52) U.S. Cl. 345/171; 345/173

(57) ABSTRACT

A method for inputting a Korean character by using a touch screen is provided. The method includes detecting touch points of a first touch and a second touch on the touch screen, displaying a consonant of a consonant input key corresponding to a center point of the detected touch points on the touch screen, and releasing the first touch and the second touch and inputting the displayed consonant as an initial sound. The method can minimize the number of character input keys arranged on the touch screen used in the portable terminal and combine the Korean character with the minimal touch action for inputting the Korean character, so that it is possible to simplify the input action for the Korean character input, thereby curtailing an input time for inputting the Korean character and effectively utilizing a limited touch screen region.

### PRIORITY

This application is a National Stage application under 35 U.S.C. §371 of an International application filed on Nov. 16, 2010 and assigned application No. PCT/KR2010/008108, and claims the benefit under 35 U.S.C. §365(b) of a Korean patent application filed in the Korean Industrial Property Office on Jan. 13, 2010 and assigned Serial No. 10-2010-0002913, the entire disclosure of which is hereby incorporated by reference.

### BACKGROUND OF THE INVENTION

1. Field of the Invention

The present invention relates to a method for inputting a Korean character on a touch screen. More particularly, the present invention relates to a method for inputting a Korean character on a touch screen, which can minimize the number of character input keys arranged on the touch screen and greatly reduce the number of keystrokes, thereby achieving a simple and fast input of Korean characters and an effective use of a limited space of the touch screen.

2. Description of the Related Art

The present invention relates to an apparatus and a method for inputting a Korean character, which minimizes the number of character input keys arranged on a touch screen adopted in an electronic device, such as a mobile phone, a Portable Media Player (PMP), a Mobile Internet Device (MID), and the like, simplifies the input of a Korean character by employing a special character input scheme, and achieves the fast input of a Korean character.

As electronic devices become compact and the touch screen emerges as a core technology, a new character input scheme capable of replacing the existing input key has been demanded.

Especially, as the Korean character requires more inputs of characters than the English alphabet, the development of a miniature character input device including a keypad designed for easy input of a Korean letter is urgently needed.

Korean patent publication No. 10-1999-0065826, entitled “System For Inputting Korean Characters And Method For Inputting Korean Vowels”, employs a phoneme combination scheme, by which it is possible to easily learn a keystroke method of the character with a concept of writing a phoneme, but a large number of keystrokes is disadvantageously required for the input of vowels.

In addition, Korean patent publication No. 10-1999-0052477, entitled “Device and Method for Inputting Korean Language”, is constructed according to a visual re-analysis, in which it is necessary to re-construct a consonant and re-construct the Korean character, so that it is a system separated from a basic algorithm of the Korean character. Moreover, it is inconvenient in that the user cannot be easily accustomed to input the characters, as well as the large number of keystrokes for the input of a consonant is necessary.

Furthermore, Korean patent registration No. 159191, entitled “Apparatus For Inputting Letters In Handset And Method thereof”, has disadvantages in that the number of keystrokes for the input of a consonant is not decreased and the user has difficulty in recognizing an order of writing in the input of a geminate vowel. That is, the Korean character input method of the related art requires too many keystrokes, which increases an erroneous input of the character, and it takes too much time for the input of the character.

Therefore, a need exists for a method for inputting a Korean character on a touch screen which greatly reduces the number of keystrokes.

### SUMMARY OF THE INVENTION

Aspects of the present invention are to address the above-mentioned problems and/or disadvantages and to provide at least the advantages described below. Accordingly, an aspect of the present invention is to provide a method for inputting a Korean character by using a touch screen, which can minimize the number of character input keys arranged on the touch screen and greatly decrease the number of keystrokes, thereby achieving a simple and fast input of the Korean character.

In accordance with an aspect of the present invention, a method for inputting a Korean character on a touch screen including a plurality of consonant input keys is provided. The method includes detecting touch points of a first touch and a second touch on the touch screen, displaying a consonant of a consonant input key corresponding to a center point of the detected touch points on the touch screen, and releasing the first touch and the second touch and inputting the displayed consonant as an initial sound.

In accordance with another aspect of the present invention, a method for inputting a Korean character on a touch screen including aplurality of consonant input keys is provided. The method includes detecting touch points of a first touch and a second touch on the touch screen, displaying a consonant of a consonant input key corresponding to a center point of the detected touch points on the touch screen, changing one of the touch points of the first touch and the second touch and changing a position of the center point, to change the displayed consonant, and releasing the first touch and the second touch and inputting the displayed consonant as an initial sound.

The position of the touch is changed through a dragging event from any one of the first touch and the second touch to a new point, or releasing any one of the first touch and the second touch and touching a new point, and a Korean vowel is displayed according to a direction of a dragging event and a number of dragging events performed after the input of the initial sound.

When a single dragging event from the input consonant input key is performed in an upward direction, a vowel “ [symbol] ” is displayed, when a single dragging event from the input consonant input key is performed in a downward direction, a vowel “ [symbol] T” is displayed, when a single dragging event from the input consonant input key is performed in a right direction, a vowel “ [symbol] ” is displayed, and when a single dragging event from the input consonant input key is performed in a left direction, a vowel “ [symbol] ” is displayed. Furthermore, when two dragging events from the input consonant input key are performed in an upward direction, a vowel “ [symbol] ” is displayed, when two dragging event from the input consonant input key are performed in a downward direction, a vowel “ [symbol] ” is displayed, when two dragging event from the input consonant input key are performed in a right direction, a vowel “ [symbol] ” is displayed, and when two dragging event from the input consonant input key are performed in a left direction, a vowel “ [symbol] ” is displayed.

When a length of the dragging event is equal to or greater than a predefined length, a vowel “ [symbol] ” is added to the displayed vowel.

In accordance with another aspect of the present invention, a method for inputting a Korean character on a touch screen based on a dragging event is provided. The method includes displaying a vowel according to a dragging event, and cancelling or displaying the displayed vowel according to a reverse dragging event performed in reverse with respect to the dragging event.

In an exemplary method for inputting the Korean character, a vowel is displayed according to a number of dragging events and a direction of the dragging event, and a vowel is displayed according to a number of dragging events, a direction of the dragging event, and a length of the dragging event.

In accordance with another aspect of the present invention, a method for inputting a Korean character on a touch screen is provided. The method includes displaying a different consonant or vowel according to a touch area on the touch screen.

In accordance with another aspect of the present invention a method for inputting a Korean character on a touch screen is provided. The method includes detecting a touch of a consonant input key, calculating a touch area of the detected touch, and when the calculated touch area is less than a predefined size, displaying a single consonant on the touch screen, and when the calculated touch area is equal to or greater than a predefined size, displaying a consonant, other than the single consonant, on the touch screen.

In accordance with another aspect of the present invention, a method for inputting a Korean character on a touch screen based on a dragging event is provided. The method includes when the dragging event is a touch dragging event having an area equal to or greater than a predefined size, displaying a geminate vowel.

Accordingly, the Korean character input method of the present invention can effectively utilize a characteristic of the multi-touch capable of recognizing at least two touch points at the same time. Furthermore, an exemplary embodiment of the present invention enables the user to visually identify the selected initial consonant and easily change the selected initial consonant, thereby reducing an error in inputting the Korean character in a limited touch screen environment.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a flowchart illustrating a Korean character input method according to an exemplary embodiment of the present invention;

FIG. 2 is a flowchart illustrating a Korean character input method according to an exemplary embodiment of the present invention;

FIGS. 3A and 3B are diagrams illustrating Korean character input methods according to exemplary embodiments of the present invention;

FIGS. 4A through 4C are diagrams illustrating Korean character input methods according to exemplary embodiments of the present invention;

FIG. 5 is a diagram illustrating a Korean character input method according to an exemplary embodiment of the present invention;

FIGS. 6A through 6C are diagrams illustrating Korean character input methods according to exemplary embodiments of the present invention; and

FIG. 7 is a flowchart illustrating a Korean consonant input method according to a size of a touch area in a Korean character input method according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Hereinafter, exemplary embodiments of the present invention will be described with reference to the accompanying drawings. In the following description, the same elements will be designated by the same reference numerals although they are shown in different drawings, and the repeated description will be omitted.

In the entire specification, when a certain unit includes a certain element, it shall be construed that another element can be further included, not be excluded, unless it is not specifically described to the contrary. Furthermore, terms “unit”, “device”, “module”, “block”, and the like, refer to a unit for processing at least one function or operation, and they can be implemented with hardware, software, or the combination of hardware and software.

In a Korean character input method according to an exemplary embodiment of the present invention, an initial consonant is input by touching first (a first touch) a consonant input key and a dragging event is performed in a predefined direction from the consonant input key while maintaining the state of the touching of the consonant input key, so that a vowel combined with the initial consonant is determined.

With regard to this, contrary to the method of the related art of directly touching a consonant input key of the touch screen and inputting an initial sound, an exemplary embodiment of the present invention provides a Korean character input method of actually detecting two touch points at the same time and selecting a consonant input key positioned at a center of the detected two touch points as an initial sound. Furthermore, when the two touch points are actually released at the same time, a consonant input key corresponding to the center of the two touch points is input as an initial consonant. Herein, the release refers to an event of the separation of a user input means from the touch screen up to a level in which a touch signal is no longer detected.

In addition, an exemplary embodiment of the present invention provides a Korean character input method in which, after the selection of an initial consonant, a vowel is determined according to a dragging event. At this time, an input vowel is sequentially deleted according to a reverse dragging event that is performed in reverse with respect to the dragging event.

Furthermore, an exemplary embodiment of the present invention provides a Korean character input method in which, even when a substantially identical point is touched for inputting a Korean character, a different Korean consonant or vowel is input according to an actual size of a touch area.

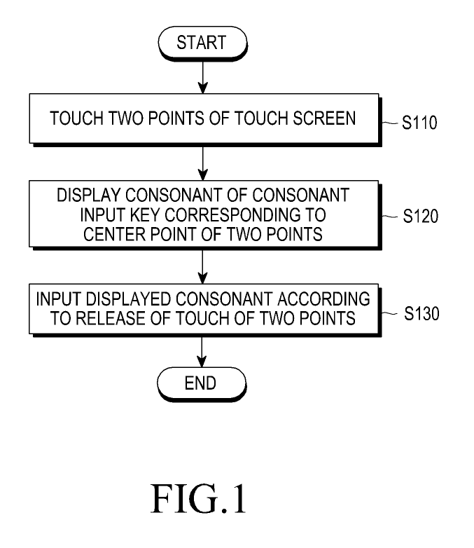

FIGS. 1 through 7, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

Hereinafter, the Korean input method according to exemplary embodiments the present invention will be described with reference to the accompanied drawings.

FIG. 1 is a flowchart illustrating a Korean character input method according to an exemplary embodiment of the present invention.

Referring to FIG. 1, in the Korean character input method, first, two points centering around any one of consonant input keys on an input window displayed on a touch screen are touched (double touch) in step S110. Here, the touch of the two points includes an action of touching a single point and touching another point while maintaining the touch of the single point, in addition to an action of touching the two points at the same time. Furthermore, the touched two points may be included within a single consonant input key area or at least one of the two touch points may be included in another consonant input key area, and at least a center point of the two touch points needs to be included in the single consonant input key area.

Thereafter, a consonant input key, in which the center point of the detected two points is included, is displayed on an output window of the touch screen in step S120. When the displayed consonant input key is a desired initial consonant, the user releases the touch of the two points, so that the displayed consonant is input as the initial consonant in step S130.

Without a simple touch of the consonant input key for the input of the initial consonant, through touching the consonant input key and releasing the touch of the consonant input key, it is possible to input the initial consonant. In such a consonant and vowel input method based on a touch-release, when the user incorrectly inputs a Korean input key, it is possible to change the input of the consonant or the vowel through changing the touch point (i.e., a kind of dragging event) while maintaining the touch state, without additional correction input (e.g., the touch of the backspace input key), which will be described below.

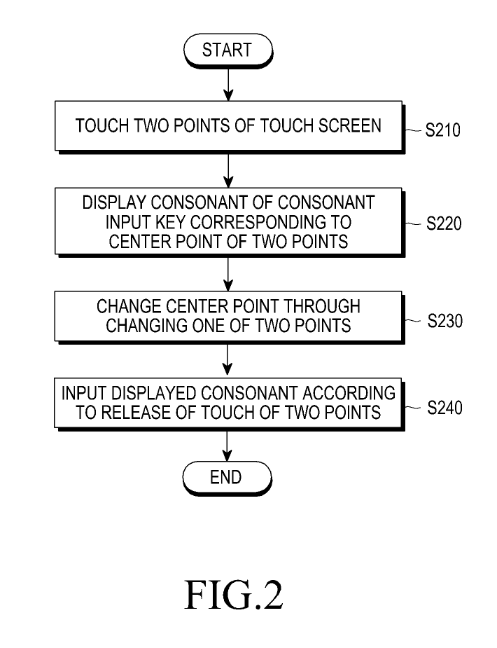

FIG. 2 is a flowchart illustrating a Korean character input method according to an exemplary embodiment of the present invention.

Referring to FIG. 2, the Korean character input method is substantially identical to the process of FIG. 1 (i.e., steps S210 and S220 are substantially identical to steps S110 and S120), but further includes step S230 of changing a center point through changing any one touch point between the two touch points.

The reference of the Korean consonant input corresponds to the touch point in the event of the single touch, but to the center point between the two touch points in the event that two touches are simultaneously performed, which has been previously described, in step S210. Especially, exemplary embodiments the present invention account for the fact that when the two touches are simultaneously performed, an input error based on the center point is relatively large in comparison with the single touch, and thus it may be imperative to correct the input error.

To this end, an exemplary embodiment the present invention provides a technical construction in which, when two touches are input, a consonant is input according to a center point of the two touch points and the center point is changed through moving any one of the two touch points. Therefore, when the changed center point moves to another consonant input key, other than the initially selected consonant input key, a new consonant is displayed on the output window. Thereafter, when the user releases the touch of the two touch points, the consonant displayed on the output window is input as an initial sound in step S240.

Hereinafter, an exemplary method for inputting and correcting a consonant will be described below.

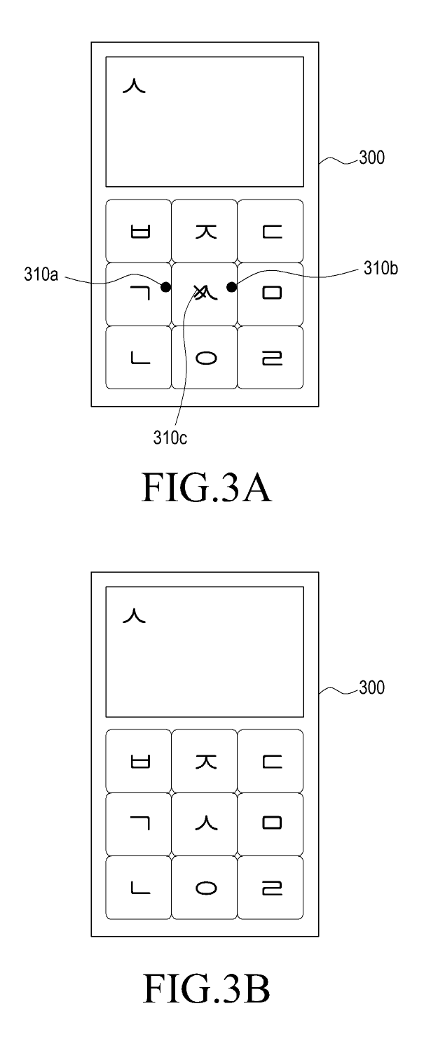

FIGS. 3A and 3B are diagrams illustrating Korean character input methods according to exemplary embodiments of the present invention.

Referring to FIG. 3A, an input window including a plurality of consonant input keys is displayed on a touch screen 300. When the user touches two points 310a and 310b centering around any one consonant input key on the input window, a Korean consonant corresponding to a center point 310c of the two touch points 310a and 310b is displayed on the touch screen.

Referring to FIG. 3B, when the user releases both of the touches of the two points, the Korean consonant displayed based on the center point of the plurality of touch points is input. In FIG. 3B, it can be noted that the center point of the two touch points is included in an area of the consonant input key “ [symbol] ” among the consonant input keys, so that the Korean consonant “ [symbol] ” is input.

In an exemplary embodiment of the present invention, only when the two touches are fully released, the consonant is input. Therefore, when any one of the touches is released or the two touches are not released, the consonant corresponding to the center point of the touch points is not input as the initial sound. Therefore, an exemplary embodiment of the present invention provides a technical construction in which through releasing only one of the plurality of touch points and touching a point again or performing a dragging event, it is possible to change a position of any one of multiple touch points and change the initial consonant according to a result of the change of the position.

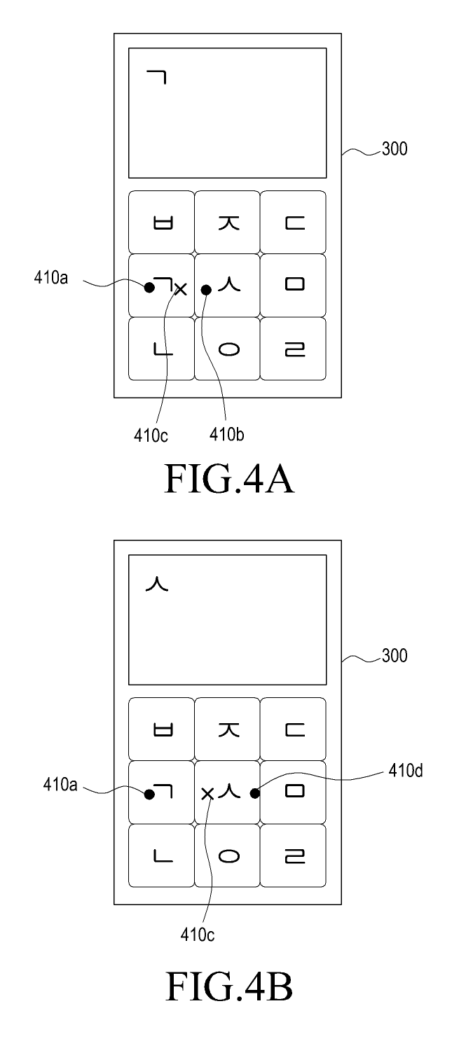

FIGS. 4A through 4C are diagrams illustrating Korean character input methods according to exemplary embodiments of the present invention.

Referring to FIG. 4A, a case in which a user desired to input the Korean consonant “ [symbol] ” as an initial consonant is illustrated However, the user incorrectly double touches an area of the Korean consonant key “ [symbol] ”, in which the touch center point 410c is included, so that the Korean consonant “ [symbol] ” is input.

Referring to FIG. 4B, one point 410b, which one of the two touch points 410a and 410b, moves to a new point 410d. The movement is performed through a scheme in which the user releases the touch of the existing touch point 410b and touches the new point 410d, or drags to the new point 410d while maintaining the touch state. However, in any case, any one of the two touch points has to be fixed because a movement of both of the two touch points can be recognized as an event for the input of a vowel. Such a vowel input method will be described below.

A center point 410c is also changed according to the movement of any one of the multiple touch points. Therefore, the center point 410c is located in the area of the Korean consonant key “ [symbol] ” and thus the Korean consonant “ [symbol] ” is displayed on the output window of the touch screen.

Referring to FIG. 4C, when the user releases the touches of the two touch points, the displayed Korean consonant “ [symbol] ” is input.

As described above, the Korean character input method can freely change the consonant through changing any one of the two touch points, and the changed consonant can be input through the release of the touches of the two touch points. Furthermore, the center point of the two touch points can be displayed on the touch screen with a discriminable scheme to help the intuition of the user. For example, the center point of the touch points can be displayed with a specific color, an icon, and the like.

Furthermore, an exemplary embodiment the present invention provides a technical construction of inputting a vowel combined with the initial consonant input through the double touch through a dragging event sequentially performed after the double touch.

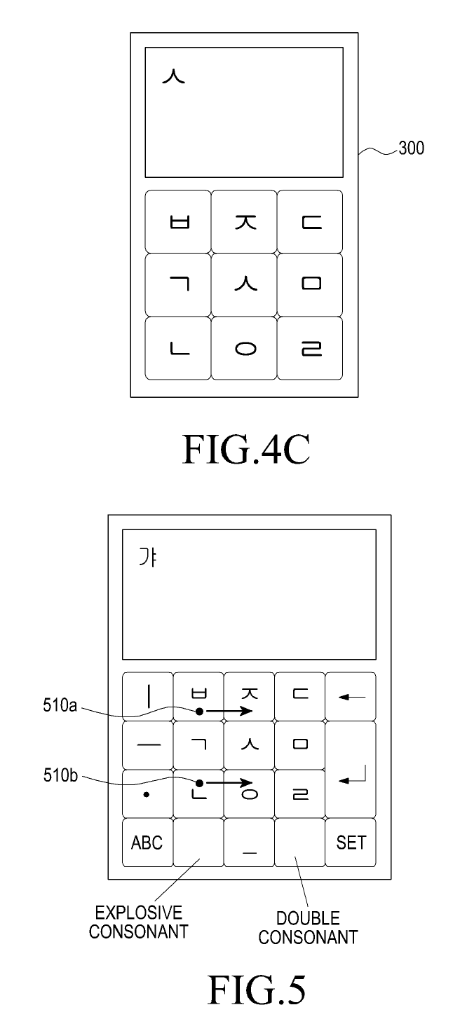

FIG. 5 is a diagram illustrating a Korean character input method according to an exemplary embodiment of the present invention.

Referring to FIG. 5, it can be noted that after the input of the initial consonant “ [symbol] ”, when the dragging event in a right direction is sequentially performed after the double touch of the touch points 510a and 510b, the Korean vowel “ [symbol] ” is combined with the input consonant “ [symbol] ”. That is, the geminate vowel “ [symbol] ”, “ [symbol] ”, “ [symbol] ” or “ [symbol] ” is input by the dragging event after the double touch that determines the initial consonant and a kind of the geminate vowel is determined according to a direction of the dragging event.

That is, when the dragging event is in a right direction, “ [symbol] ” is input as a middle vowel, when the dragging event is in a left direction, “ [symbol] ” is input as a middle vowel, when the dragging event is in a downward direction, “ [symbol] ”is input as a middle vowel, and when the dragging event is in an upward direction, “ [symbol] ” is input as a middle vowel. In a similar manner, the single vowel “ [symbol] ”, “ [symbol] ”, “ [symbol] ”, or “ [symbol] ” is input according to the dragging event after the single touch, and a kind of the single vowel is determined with the same method of the geminate vowel.

In an exemplary embodiment of the present invention, when the dragging event is performed from the two touches, the dragging event is determined as an event for inputting a vowel. However, when the dragging event is performed from the single touch, the dragging event is determined as an event for changing the center point, so that it is possible to input a new consonant as previously described.

Furthermore, the Korean character input method provides a technical construction, which can cancel the input vowel through a reverse dragging event performed in a reverse direction with respect to the dragging event, after the dragging event for inputting the vowel.

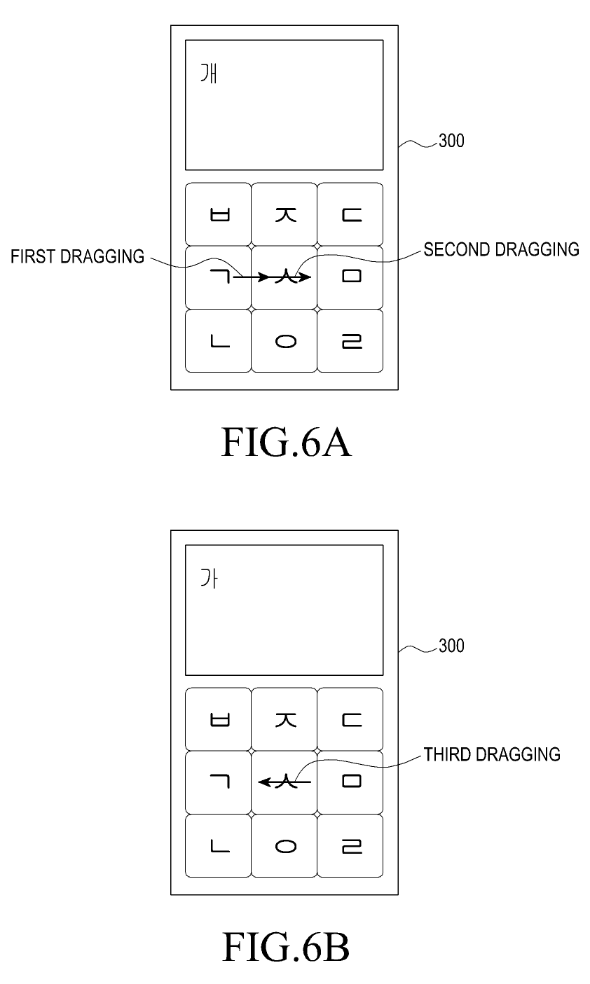

FIGS. 6A through 6C are diagrams illustrating Korean character input methods according to exemplary embodiments of the present invention.

Referring to FIG. 6A, when a user touches a Korean consonant and performs a first dragging event in a right direction, the vowel “ [symbol] ” is displayed on a touch screen according to the first dragging event. When the user drags again in the right direction further, the vowel “ [symbol] ” is input. Therefore, an exemplary embodiment of the present invention provides the Korean character input method for adding a stroke according to a length of the dragging event, and further provides a technical construction of cancelling or deleting the added stroke or the single vowel according to the reverse dragging event.

FIG. 6B illustrates a case in which, after the performance of a second dragging event by which the Korean phoneme “ [symbol] ” is displayed, a third dragging event is sequentially performed in a left direction.

Referring to FIG. 6B, it can be noted that the vowel ‘ [symbol] ’ added by the second dragging event is cancelled according to the reverse dragging event, so that the vowel “ [symbol] ” is converted to the vowel “ [symbol] ”. Therefore, the Korean character input method provides the construction, in which the Korean vowel is input according to a direction, the number, and a length of the dragging event, and cancelling the input vowel through the reverse dragging event step by step.

Referring to FIG. 6C, when the user performs a dragging event in a left direction further (i.e., a fourth dragging event), the vowel “ [symbol] ” input by the first dragging event is also cancelled. Therefore, a stepwise construction of the length of the dragging event for inputting the vowel is substantially identically applied to the reverse dragging event for cancelling the input vowel.

Furthermore, an exemplary embodiment of the present invention provides a technical construction of using a touch area on the touch screen in the input of the Korean consonant and vowel. In order to implement the technical construction, an electronic device based on the touch screen includes a touch detector capable of recognizing a touch area. For example, infrared rays, and the like, passing a predefined height of the touch screen in a lattice shape can be used as an element for the touch detector for recognizing the touch area, but the scope of the present invention is not limited thereto.

The Korean character input method has a technical construction of displaying a different consonant or vowel according to the touch area on the touch screen. That is, when the substantially identical position is touched and the dragging event is performed, a different consonant or vowel is input according to the touch area on the touch screen.

An exemplary embodiment of the present invention provides the consonant input method according to the touch area.

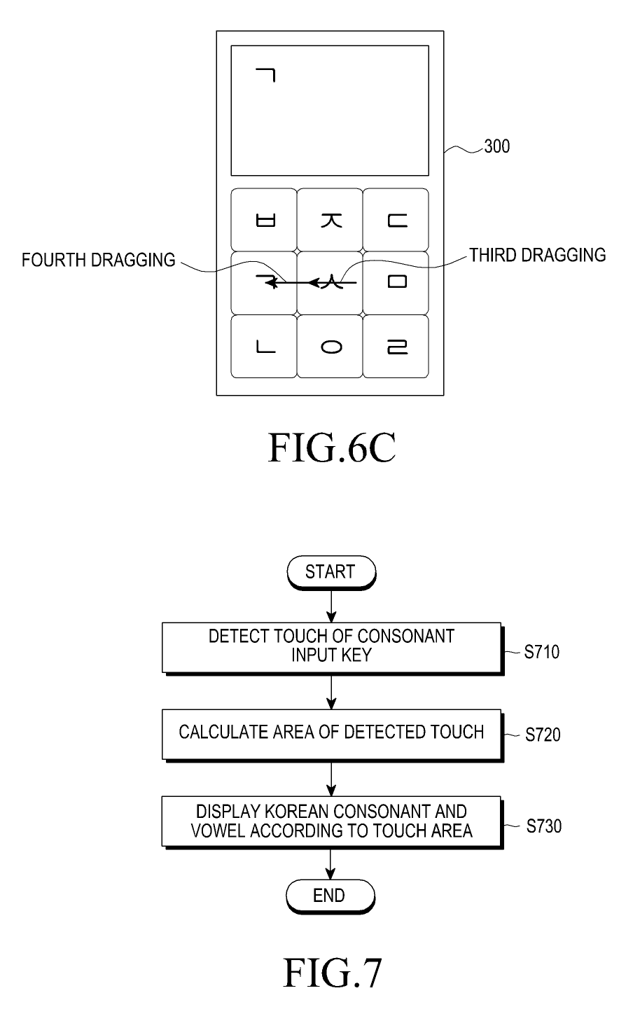

FIG. 7 is a flowchart illustrating a Korean consonant input method according to a size of a touch area in a Korean character input method according to an exemplary embodiment of the present invention.

Referring to FIG. 7, a touch for a consonant input key is detected in step S710. Thereafter, a touch area of a position of the detected touch is calculated in step S720. The touch area can be calculated by various methods.

In step S730, the Korean consonant or vowel is displayed and determined according to the touch area. The determination of the Korean consonant or vowel according to the touch area can be applied to both of consonant and vowel, which will be described below.

When the calculated touch area is less than a predefined size, a single consonant, such as “ [symbol] ” or “ [symbol] ”, is displayed on the touch screen. When the calculated touch area is equal to or greater than a predefined size, a double consonant, such as “ [symbol] ” or “ [symbol] ”, or an explosive consonant, such as “ [symbol] ” or “ [symbol] ”, other than the single consonant, is displayed on the touch screen. The displayed basic consonant is determined according to the touched consonant input key, which is substantially identical to the related art, so that its description will be omitted. The displayed consonant can be input as an initial consonant through the sequential release of the touch or the dragging event from the consonant input key.

An exemplary embodiment of the present invention provides the Korean character input method for inputting a single vowel or a geminate vowel according to the touch area. That is, the Korean character input method of the present invention has a technical construction of displaying the geminate vowel when the dragging event is a touch dragging event having an area equal to or greater than a predefined size.

That is, when the touch dragging event having an area equal to or greater than a predefined size is performed, a geminate vowel, such as ‘ [symbol] ’, ‘ [symbol] ’, ‘ [symbol] ’, and ‘ [symbol] ’, is displayed. However, when the touch dragging event having an area less than a predefined size is performed, a single vowel, such as ‘ [symbol] ’, ‘ [symbol] ’, ‘ [symbol] ’, and ‘ [symbol] ’, is displayed. That is, even if the number of touches and the direction of the dragging event is substantially identical, it is possible to discriminate and input the vowel only with the touch area. The scope of the present invention is not limited to the aforementioned exemplary embodiments, and every technical construction capable of selectively changing the consonant and vowel input according to the touch area on the touch screen (i.e., the touch area on the input window of the Korean consonants and vowels) belongs to the scope of the present invention, and further the present invention is not limited to this technical construction.

Accordingly, the Korean character input method can effectively utilize a characteristic of the multi-touch capable of recognizing at least two touch points at the same time. Furthermore, an exemplary embodiment of the present invention enables the user to visually identify the selected initial consonant and easily change the selected initial consonant, thereby reducing an error in inputting the Korean character in a limited touch screen environment.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A method for inputting a Korean character on a touch screen including a plurality of consonant input keys, the method comprising:
detecting touch points of a first touch and a second touch on the touch screen;
displaying a consonant of a consonant input key corresponding to a center point of the detected touch points on the touch screen; and
releasing the first touch and the second touch and inputting the displayed consonant as an initial sound.

2. A method for inputting a Korean character on a touch screen including a plurality of consonant input keys, the method comprising:
detecting touch points of a first touch and a second touch on the touch screen;
displaying a consonant of a consonant input key corresponding to a center point of the detected touch points on the touch screen;
changing one of the touch points of the first touch and the second touch and changing a position of the center point, to change the displayed consonant; and
releasing the first touch and the second touch and inputting the displayed consonant as an initial sound.

3. The method of claim 2, wherein the position of the touch is changed through a dragging event from any one of the first touch and the second touch to a new point, or releasing any one of the first touch and the second touch and touching a new point.

4. The method of claim 1, wherein a Korean vowel is displayed according to a direction of a dragging event and a number of dragging events performed after the input of the initial sound.

5. The method of claim 4, wherein when a single dragging event from the input consonant input key is performed in an upward direction, a vowel “ [symbol] ” is displayed, when a single dragging event from the input consonant input key is performed in a downward direction, a vowel “ [symbol] ” is displayed, when a single dragging event from the input consonant input key is performed in a right direction, a vowel “ [symbol] ” is displayed, and when a single dragging event from the input consonant input key is performed in a left direction, a vowel “ [symbol] ” is displayed.

6. The method of claim 4, wherein when two dragging events from the input consonant input key are performed in an upward direction, a vowel “ [symbol] ” is displayed, when two dragging events from the input consonant input key are performed in a downward direction, a vowel “ [symbol] ” is displayed, when two dragging events from the input consonant input key are performed in a right direction, a vowel “ [symbol] ” is displayed, and when two dragging events from the input consonant input key are performed in a left direction, a vowel “ [symbol] ” is displayed.

7. The method of claim 5, wherein when a length of the dragging event is equal to or greater than a predefined length, a vowel “ [symbol] ” is added to the displayed vowel.

8. The method of claim 6, wherein when a length of the dragging event is equal to or greater than a predefined length, a vowel “ [symbol] ” is added to the displayed vowel.

9. A method for inputting a Korean character on a touch screen based on a dragging event, the method comprising:
displaying a vowel according to a dragging event; and
cancelling or displaying the displayed vowel according to a reverse dragging event performed in reverse with respect to the dragging event.

10. The method of claim 9, wherein a vowel is displayed according to a number of dragging events and a direction of the dragging event.

11. The method of claim 9, wherein a vowel is displayed according to at least one of a number of dragging events, a direction of the dragging event, and a length of the dragging event.

12. A method for inputting a Korean character on a touch screen, the method comprising:
displaying a different consonant or vowel according to a touch area on the touch screen.

13. A method for inputting a Korean character on a touch screen, the method comprising:
detecting a touch of a consonant input key;
calculating a touch area of the detected touch;
when the calculated touch area is less than a predefined size, displaying a single consonant on the touch screen; and when the calculated touch area is equal to or greater than a predefined size, displaying a consonant, other than the single consonant, on the touch screen.

14. A method for inputting a Korean character on a touch screen based on a dragging event, the method comprising:
when the dragging event is a touch dragging event having an area equal to or greater than a predefined size, displaying a geminate vowel.

15. The method of claim 2, wherein a Korean vowel is displayed according to a direction of a dragging event and a number of dragging events performed after the input of the initial sound.

16. The method of claim 15, wherein when a single dragging event from the input consonant input key is performed in an upward direction, a vowel “ [symbol] ” is displayed, when a single dragging event from the input consonant input key is performed in a downward direction, a vowel “ [symbol] ” is displayed, when a single dragging event from the input consonant input key is performed in a right direction, a vowel “ [symbol] ” is displayed, and when a single dragging event from the input consonant input key is performed in a left direction, a vowel “ [symbol] ” is displayed.

17. The method of claim 15, wherein when two dragging events from the input consonant input key are performed in an upward direction, a vowel “ [symbol] ” is displayed, when two dragging events from the input consonant input key are performed in a downward direction, a vowel “ [symbol] ” is displayed, when two dragging events from the input consonant input key are performed in a right direction, a vowel “ [symbol] ” is displayed, and when two dragging events from the input consonant input key are performed in a left direction, a vowel “ [symbol] ” is displayed.

18. The method of claim 16, wherein when a length of the dragging event is equal to or greater than a predefined length, a vowel “ [symbol] ” is added to the displayed vowel.

19. The method of claim 17, wherein when a length of the dragging event is equal to or greater than a predefined length, a vowel “ [symbol] ” is added to the displayed vowel.
